(19) United States
(12) Patent Application Publication
(10) Pub. No.: US 2005/0220236 A1
(43) Pub. Date: Oct. 6, 2005

(54) Data receiver with servo controlled delayed clock

(76) Inventor: Glenn Wood, Colorado Springs, CO (US)

Correspondence Address: AGILENT TECHNOLOGIES, INC.;Legal Department, DL429, Intellectual Property Administration, P.O. Box 7599, Loveland, CO, 80537-0599, US

(21) Appl. No.: 10/815,156

(22) Filed: Mar. 31, 2004

(51) Int. Cl. H04L 7/00

(52) U.S. Cl. 375/355

(57) ABSTRACT

A Time Ruler is used to periodically discover the Unit Interval (UI) for a data signal, which does not change abruptly, but drifts with time and various parameters. The same Time Ruler can also be used at other times to determine where in the Measured UI the data is being clocked (clock phase). Since the present size of the UI is thus known through discovery, the clock signal can be adjustably delayed in response to an error signal to keep its active edge in the middle of the measured UI. The delayed clock signal can be produced from a clock delay line whose step size cooperates with the step size of the Time Ruler, and that can insert and remove stages of clock delay as a function of the error signal. The error signal is a shifted version of a collection of XOR's derived from latched clock phase information produced by the Time Ruler. The amount and direction of the shifting is a function of the Measured UI.

### REFERENCE TO RELATED APPLICATION

This Application is related to the subject matter of a co-pending U.S. patent application Ser. No. <unknown> filed on the same day as this one, and entitled UNIT INTERVAL DISCOVERY FOR A BUS RECEIVER. That Application describes a technique for learning the Unit Interval of a signal, which information is utilized by the servo technique described in the instant Application. For that reason, and for the sake of brevity herein, UNIT INTERVAL DISCOVERY FOR A BUS RECEIVER is hereby incorporated herein by reference.

### BACKGROUND OF THE INVENTION

Consider a digital system wherein a communications path, such as a bus, transmits both a clock and some accompanying data. The communications path could also be a radio link accompanied by a clock recovery mechanism. Typically, the phase of the clock is delayed by a half-cycle of the data, so that the data has time to set up, whereupon a transition in the clock indicates that it is time to capture the value of the data, which might be a logical ONE or a logical ZERO. As is well known, temperature variations, power supply drift, higher speeds, longer data paths, wider bus widths and various forms of interference all conspire to degrade timing and voltage margins, all of which can cause drift in both Unit Interval and clock placement (the phase of the clock) within the Unit Interval.

Other, more fundamental circumstances can sometimes cause the Unit Interval to appear to shift. Consider a fast moving vehicle, such as an orbiting spacecraft. Telemetry from the vehicle can be affected by Doppler shift. For example, suppose the vehicle transmits simple binary pulses at a 10 Mc rate on a carrier frequency of 1 GHz. Let-us say that no expense was spared in equipping the vehicle with first rate stuff, and that it has an onboard frequency standard good to parts in 10¹⁴. It has internal logic that effectively counts one hundred internal cycles of that standard to make each of its ONEs and ZEROs for the binary pulse modulation, so as far as it is concerned, the Unit Interval is exactly correct with no appreciable drift, ever. But to an observing receiver, say on the earth as the vehicle orbits the moon, those one hundred cycles of carrier present (a ONE) and one hundred cycles of carrier otherwise (a ZERO) are, while still exactly(!) one hundred cycles each, are not at 1.000,000 . . . GHz. Instead, they are at a frequency determined by the Doppler shift. Thus, the Unit Interval is one hundred cycles at that different frequency, and is not the nominal 100.000 . . . nsec. This effect is quite apart from any relativistic effects, and needs to be attended to when data rates get high enough that the change in Unit Interval owing to Doppler shift gets to be a significant percentage of the nominal Unit Interval. Say, suppose the data rate were 100 Mc, with just ten cycles of carrier per bit. Now, whatever Doppler induced clock positioning error that might have been tolerable in the 10 Mc case is much worse.

These assorted difficulties have led to various strategies of compensation. One such strategy is to periodically train the receiver mechanism by transmitting a known pattern of data, so that the receiver can adjust the phasing of the clock to an optimum value that maximizes the correct capture of those known patterns. There are number of disadvantages connected with this approach.

These disadvantages include the extra overhead on the bus needed to transmit the training patterns, and the extra logic needed in the receiver mechanism to recognize them and respond to them. It may be difficult to develop a short training sequence that effectively treats all the possibilities that might arise, and a robust training sequence may significantly increase bus overhead. Generally, the receiver mechanism itself cannot initiate re-training, and there is no guarantee that correct operation will be continuously maintained during the interval between training sequences. In the case of a remote transmitter not subject to effective control by the receiver, the receiver simply has to cope with the situation it encounters.

It would be desirable if there were a way to make the receiver mechanism self-sufficient in regard to an ability to continuously sample the data at the optimum time (proper clock phasing) despite changes in the Unit Interval, and free the receiver from needing periodic training sequences, and the sending agency from having to send them. A worthy goal, indeed, but how to do it?

### SUMMARY OF THE INVENTION

A data signal, which if a member of a bus has parameters that may be taken as representative of those same parameters for the various other data signals of the bus, is applied to a circuit that discovers its Unit Interval (UI). The UI is not expected to change abruptly, but to drift with time and various environmental parameters. That UI information is produced as needed and in a form that allows it to be combined with knowledge about the present and unadjusted location of the active edge of the clock. The result is an error signal applied to a clock delay circuit to position the active edge of the clock signal in the middle of the measured UI.

The basic technique for UI discovery is the subject of the incorporated UNIT INTERVAL DISCOVERY FOR A BUS RECEIVER, and we shall give here only the briefest of summaries as a convenience to the reader: The selected data signal is applied to a Time Ruler (tapped data delay line, going from, say, left to right) whose overall delay is at least one unit interval. The various increasingly delayed data values present at the taps of the delay line for an isolated ONE are clocked into respective cells of a sticky ZEROs register previously initialized to all ONEs, and, if also desired for an isolated ZERO, into respective cells of a sticky ONEs register previously initialized to all ZEROs. The sticky ZEROs register SZERO measures UI(ONE), which is the unit interval of a ONE. Assuming that the active edge of a bus signal is the rising edge, the inversion of the selected data signal is used to clock SZERO, while the non-inverted signal clocks SONE. Over a period of time following initialization, the data signal can be expected to experience isolated ONEs (i.e., a single ONE with ZEROs before and after) and similarly isolated ZEROs. A ONE to ZERO transition in the data will clock any far-to-the-right ZEROs in the tapped delay line into SZERO, which become sticky and trim the indication of UI(ONE) in left-most and remaining initial ONEs. In similar fashion, a ZERO to ONE transition in the data will clock any far-to-the-right ONEs in the tapped delay line into SONE, which become sticky and trim the indication of UI(ZERO) in left-most and remaining initial ZEROs. The UI(ONE) can be combined (e.g., averaging) with UI(ZERO) to produce a unified UI result.

Returning now to the present issue, since UI information needs to be obtained only periodically during a Unit Interval Discovery Mode, the Time Ruler used in that process can be put to another use when not used to find UI information. In particular, it can be used in a Clock Servo Mode to determine where in the actual UI the data is being clocked. Since the present size of the UI is known, the clock signal can be adjustably delayed as needed to keep its active edge in the middle of the measured UI. The servomechanism that adjustably delays the clock is responsive to incremental error information (so that nothing changes if the servo loop is interrupted and no error signal is produced), so that during times when the Time Ruler is temporarily in use for UI discovery purposes or is otherwise silent, the most recent adjusted clock delay is maintained until active servoing can resume.

In the Clock Servo Mode, the selected data signal is still applied to the Time Ruler, but the various increasingly delayed data values present at the taps are clocked into respective latches by a delayed clock that has been delayed by a particular amount that can be varied. The position of a transition in the latched data is indicative of the phase of the delayed clock as delayed by the current particular amount. That is, if there were a transition in the latched delayed data, its position is a sampling-phase indication that would ideally appear at a location corresponding to half the unit interval. A bank of XOR gates detects the presence of such a transition between adjacent latches. The location of such a transition of interest in the latched data is an ordinal number associated with an ordering of the latches along the tapped delay line. That number can be combined with a knowledge of the measured unit interval (a similar ordinal number), and a servo error signal produced that, when applied to a variable clock delay circuit, increases the current particular amount of delay for the clock when the number (delay) is too low, and decreases it when the number (delay) is too high. In the temporary absence of such a detected transition (caused by strings of consecutive ONEs or ZEROs) the servo simply coasts by maintaining the most recent correction until another transition is detected.

The delayed clock signal can be produced from an adjustable tapped clock delay line that matches the step size of the data delay, and that can insert and remove stages of clock delay as a function of the servo error signal. More than one data channel can be applied to corresponding additional data delay lines, and multiple initial servo signals produced, which may then be averaged or otherwise combined to produce a single final servo signal used for the bus as a whole. This latter technique has the advantage that, as more data channels are considered, it can be expected that there will be less inhibiting of the servo's operation owing to consecutive ONEs or ZEROs in the data, since different channels can be expected to transmit different patterns of bits, while it remains probable that the drift in clock phase being corrected for is essentially the same for all signals in the bus.

### BRIEF DESCRIPTION OF THE DRAWINGS

FIG. 1 is a simplified block diagram of a related art technique for discovering Unit Interval using a Time Ruler, and which is of interest to the present technique of controlling the phase of a clock signal for sampling a data signal within its Unit Interval;

FIG. 2 is a simplified block diagram of a circuit for positioning the active edge of a clock signal in the middle of a Unit Interval whose length may vary;

FIG. 3 is a simplified block diagram of a servo-controlled variable delay element used in the circuit of FIG. 2; and

FIG. 4 is a simplified block diagram of the functional behavior of a Selection Matrix used in the circuit of FIG. 2.

### DESCRIPTION OF A PREFERRED EMBODIMENT

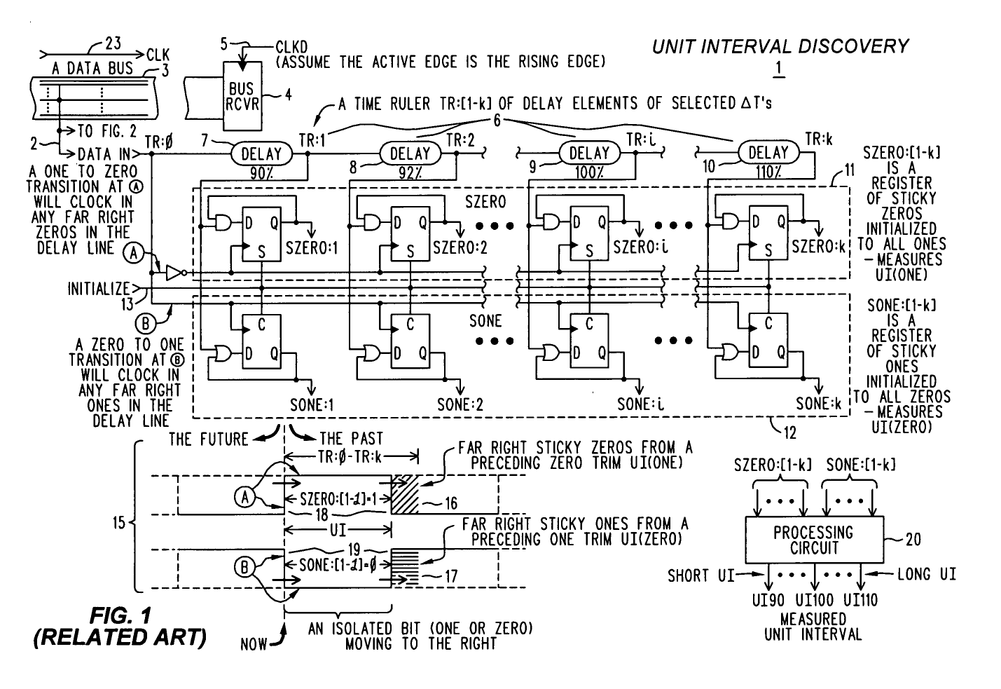

Refer now to FIG. 1, wherein is shown a simplified representation 1 of a related art technique for discovering Unit Interval using a Time Ruler, and which is the subject of the incorporated UNIT INTERVAL DISCOVERY FOR A BUS RECEIVER. For the convenience of the reader, and for the sake of completeness, we now give a very abbreviated description of that technique, while remaining mindful that the full disaster is described in detail in UNIT INTERVAL DISCOVERY FOR A BUS RECEIVER.

FIG. 1 discovers the Unit Interval of a ONE bit [UI(ONE)] and also that of a ZERO bit [UI(ZERO)] for a signal 2. The signal 2 is a particular individual signal whose UI is of interest, and may be taken as representative of circumstances associated with an entire bus 3 whose signals are to be received by a BUS RECEIVER 4 that is clocked by a signal CLKD 5. By adjusting a delay associated with CLKD the data is clocked in the middle of the Unit Interval.

To that end, we apply the signal 2 to a Time Ruler 6 composed of a number of cascaded delay elements (7, 8, 9, . . . 10). These delay elements may be any of the well-know sort that delay an edge for a digital signal, such as each delay element being a series of one or more cascaded buffers. The leading, or first, delay element can have a substantially larger delay than the others. In any event, the total amount of delay from input to final output at the end of the Time Ruler is at least as long as the longest expected Unit Interval.

So, let us: (1) Say that there are k-many delay elements; (2) Call the signal selected for application to the Time Ruler “DATA IN”; and (3) Designate the various delayed versions, register style, as TR:1, TR:2, . . . TR:i, . . . TR:k. The entire collection could be referred to as TR:[0-k]. Thus, TR:0 is simply DATA IN, and the various TR:i are the k-many successively delayed signals (i.e., instances of some earlier DATA IN).

Now consider two registers, SZERO 11 and SONE 12, whose latching elements are “sticky” for ZEROs and ONEs, respectively, and that are initialized and clocked as will be described. Each register has as many latching elements, or cells, as there are delay elements. That is, each register has k-many cells, which are denoted as SZERO:[1-k] and SONE:[1-k]. SZERO stands for “StickyZEROs,” and will be initialized to all ONEs, while SONE stands for “Sticky ONEs,” and will be initialized to all ZEROs. Each cell of SZERO is the same, and each cell of SONE is the same, although the devices for initializing and for making SONE sticky are different from SZERO.

When we want to get UI information we arrange that there be an instance of the signal INITIALIZE 13. Then we let the thing run for some period of time, say for several hundred or several thousand clock cycles of the bus 3. Then we get SZERO:[1-k] and SONE:[1-k] and process them to obtain a unified indication of the Measured Unit Interval.

So, let us consider the situation for SZERO as a trailing edge of an isolated ONE arrives at the entrance to the Time Ruler 6. By the term “isolated” we mean a ONE that is both preceded and followed by a ZERO. We accept that such an event is not guaranteed to occur on any given bus cycle, but that it is bound to happen at least occasionally. We are prepared to wait until at least several, or even until many, such isolated ONEs have occurred before we unload SZERO. We will also, of course, remember that at the very beginning of the measurement for UI(ONE) an instance of INITIALIZE 13 set all the bits of SZERO to ONEs.

To continue, the inverter 14 arranges that the trailing edge of an isolated ONE provides the rising edge that clocks all the latches in SZERO. Now, and with reference also to diagram 15, if indeed we have an isolated ONE, TR:1 through some other Time Ruler element, say, TR:j, will all get ONEs (18) clocked into the corresponding latches of SZERO. The latches corresponding to TRj+1 through TR:k will get ZEROs (because of the preceding ZERO). It is, of course, the next (following ZERO) that provides the transition (A) that is inverted by inverter 14 to cause the clocking of the latches of SZERO. Those ZEROs for TR:j+1 through TR:k will activate the sticky ZERO property, and duly get stuck, as indicated by the diagonal shading 16. For the same reason, any subsequent isolated ONE that has, according to the Time Ruler's outputs, a shorter UI(ONE) will create a larger number of such stuck ZEROs at the end of that shorter ONE. Longer periods for subsequent isolated ONEs will NOT “unstick” the stuck ZEROs. This “trims” the indicated UI(ONE) to be the shortest observed length, in units of delay ΔT, at least for the duration of the measurement, so far. This indicated length is a series of remaining consecutive ONEs.

We have treated the ZERO ONE ZERO case (an isolated ONE). Upon reflection, it is clear why the other possibilities (ZERO ONE ONE, ONE ONE ZERO, ONE ONE ONE and any case with ZERO in the middle) do not disturb the above-described results. That is, unless there is a subsequent ZERO (following the isolated ONE) there is no possibility of clocking SZERO at transition A, and SZERO remains undisturbed. And unless there was a preceding ZERO (far to the right in the diagram) there simply are no far right ZEROs to clock into SZERO and become stuck.

Now consider SONE. It will, of course, previously have been initialized to all ZEROs. The trailing edge of an isolated ZERO provides the transition at B that clocks all the latches in SONE. Its operation is similar to that of SZERO, although the sticky mechanism is slightly different and the final trimmed indication is a series of remaining consecutive ZEROs.

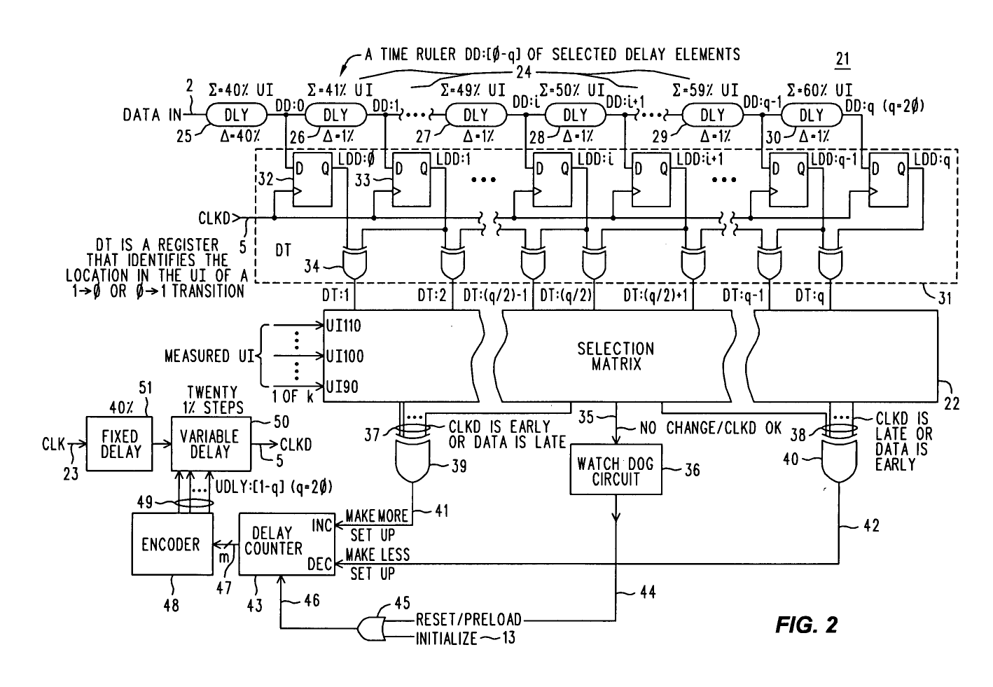

Note Processing Circuit 20, whose output is an indication of the Measured Unit Interval, UI90 through UI110. The numbers refer to percentages of the nominal UI, and it is assumed in this example that only one of the signals in this family is TRUE at any one time. The Processing Circuit 20 itself can be a small microprocessor, spare capacity in a computing facility provided for some other purpose, a look-up table, state machine or other arrangement of logic circuitry. The processing itself could be averaging. The Measured Unit Interval signals (the UI:i) are coupled to a Selection Matrix 22 in FIG. 2.

We don't show in the figures an expansion of what goes on inside the Processing Circuit 20, but it is not mysterious. To show that it is not, we now sketch some possibilities. The inputs are the consecutive ONEs 18 of SZERO within the entire field SZERO:[1-k], and the consecutive ZEROs 19 of SONE within the entire field SONE:[1-k]. While these signals do represent numerical values (in units related to ΔT), they do it in a positional, or literal sense. That is, to represent the abstract idea of “five” they (for, say, SZERO) do it as the string of symbols “1 1 1 1 1 0 0 . . . ”, rather than as an encoded 0101 (binary) or the five-bit or seven-bit ASCII code for “5”. It is like the aborigine that records the number of game at a spot by putting thirteen pebbles in a pouch, one pebble for each animal, to enforce a one-to-one correspondence. While addition and subtraction using such literal representations is not too difficult, averaging such values might be a bit of a challenge, so the likely solution is to either use a look-up table or apply the literal representations to encoders to get regular binary that is easily manipulated arithmetically. In any event, the combined (output) result of the two inputs is shown as being a 1-of-N type format that is neither the same as the literal representation nor is a normal arabic style encoding using fixed symbols and a radix. If a look-up table were used, then the various combinations of the UI90-UI110 outputs would be that which is “looked-up,” or else an 1-of-N line encoder would produce them based on an encoded value for the combination of the inputs.

The choice of using a 1-of-N style signal for UI90 . . . UI110 is motivated by the way the particular Selection Matrix 22 of FIG. 2 is going to use them. (It is a “select a row” type of mechanism, and the 1-of-N style signaling simplifies that task. If the Selection Matrix 22 of FIG. 2 were replaced by a look up table instead, then an encoding of the combined inputs to the Processing Circuit 20 would be a preferred output, and the in-line representation for the Measured Unit Interval would never be needed or produced.)

Now, suppose that it has been determined that a worst case of a ten percent change in UI is all that would ever have to be dealt with. So, for the moment, suppose that k is twelve, and also arrange that TR:1 be 90% of the nominal UI; with ΔT for the other TR:i set at 2%. Now, TR: 1 plus TR:[2-5] are 100%, and the measurement can range all the way down to just 90% with TR:1 alone, and range up to 110% with the full TR:0 plus TR:[2-12], all in step of 2%. Let's also suppose that we have been operating for a while with a measured UI of 100%, which is right where it ought to be. Some other mechanism (which we will get to in a bit) has been keeping CLKD 5 right in the middle of that UI. Presumably that other mechanism operates in steps that include a location that corresponds to exactly half the UI, or very close to it. Now let the UI go down by 2%. Where, relative to the old 50% location is the new 50% location? It is not at a 2% change, for that is for the entire UI. The middle of the (new) UI moves over only 1%, so the answer is 49%. Hmmm . . . . this suggest that if we want to use the same delay line hardware for both the Unit Interval Discovery Mode and the Clock Servo Mode, we have some sort of a two-to-one issue to deal with.

(We shall have more to say about this issue in due course, and for now will simply outline certain possibilities. From a functional point of view, we need three delay lines, one of which needs to be variable to adjust the position of CLK as CLKD. The other two are for the Unit Interval Discovery Mode and the Clock Servo Mode, but they are quite likely never both needed at the same time, so we are tempted to use one set of hardware for both. We could indeed have two separate sets, which would afford certain extra operational range and perhaps some additional flexibility. It is also perhaps extravagant, while sharing is elegant. In the figures we have not explicitly made the “two” shared delay lines the same as to notation (it would likely be confusing at first) although such sharing is the plan, and have instead settled for letting them seem at first to be separate while assigning numerical values that will turn out to be consistent with such sharing. The two-to-one issue mentioned above figures into what those numbers are, and where they come from won't make a lot of sense unless one has an appreciation of that two-to-one issue and a suspicion that the intent is to use shared hardware.)

To continue, refer now to FIG. 2, which is a simplified block diagram 21 of hardware that accomplishes the Clock Servo Mode. A Time Ruler DD:[0-q] (24) has an initial 40% of UI delay (25), followed by a series (26-30) of consecutive 1% delays that end with a total cumulative delay of 60%. These delayed instances of Data In are termed the various DD:i that appear in the figure. (DD stands for Delayed Data.) The various DD:i are respectively coupled to the D inputs of corresponding latches, of which 32 and 33 are representative. The outputs of the latches are labeled LDD:[0-q] (for Latched Delayed Data). Each consecutive pair of latches drives an associated XOR gate, of which 34 is representative. The outputs of the XOR gates are DT:[1-q] (DT stands for Data Transition). The idea here is that if the data entering the Time Ruler DD:i (24) contains a transition, then there will be an adjacent ZERO ONE or ONE ZERO in the LDD:i . The location of that transition is indicated by an associated XOR gate output that goes TRUE, while the others remain FALSE. (We assume that UI will NEVER legitimately get so short as to allow two transitions within the 20% coverage of the Time Ruler 24!) Also, the location of the transition (which XOR gate went TRUE) indicates the amount of set up prior to clocking, if we also know the UI. So, we plan on combining the DT:i with the Measured Unit Interval (UI90, . . . , UI110) to derive a set of signals that can be used to keep set up right at 50% of Measured UI, even though either or both of clock phase and actual UI might be drifting.

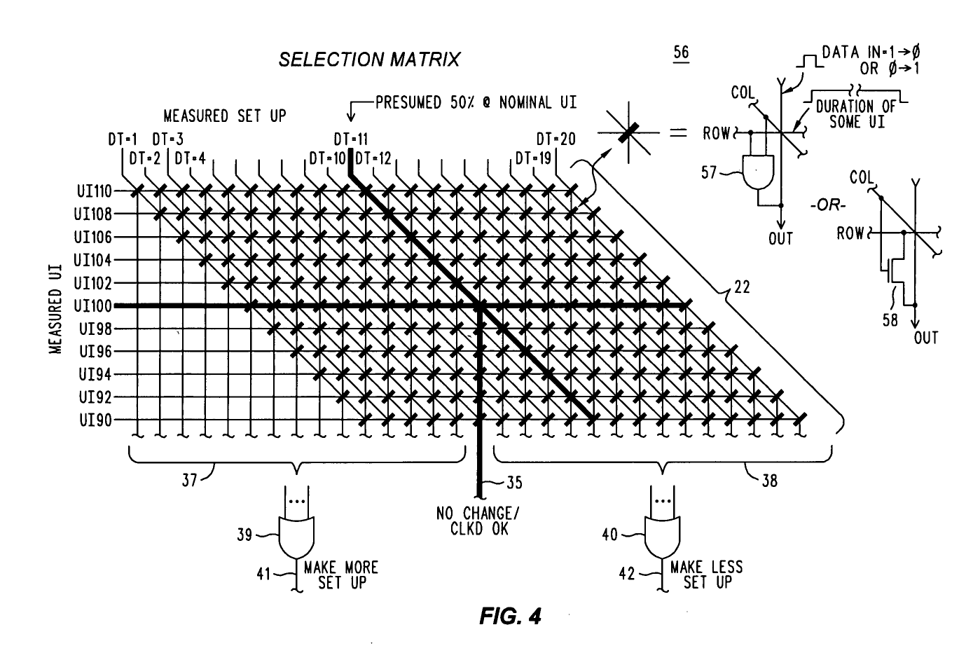

To that end, the DT:i and the Measured UI are applied to a Selection Matrix 22. The details of its electrical operation will be discussed in connection with FIG. 4. For now it is sufficient to appreciate its logical operation if we knew that when the UI is 100% of nominal, then a particular DT:i (namely, DT:q/2, or one adjacent to it) would be the XOR gate output that would be produced for 50% set up. If that were to happen, then we would not need to do anything:set up is fine. One the other hand, a DT:(q/2)+3 would definitely be an indication that less set up was needed. (Why it is less set up and not more will become clear when we open the hood and look inside the Selection Matrix, combined with an appreciation of the conventions surrounding the operation of the Delay Counter 43.) In fact, any DT:i, where i>(q/2) is such an indication (assuming we have designated q/2 as the “middle”). All those other DT signals (38) can be OR'ed together by OR gate 40 to create a signal 42 used to make less set up. In similar fashion, any DT:i, where i<(q/2) is an indication that more set up is needed. All of those DT signals (37) can be OR'ed together by OR gate 39 to create a signal 41 used to make more set up.

In fact, if we knew that the UI were going to stay solidly at 100%, we would not need the Measured UI signals at all, and would servo the phase of CLKD simply by observing the DT:i. We would think of them as a field of 1-of-N indications partitioned into three sections:more set up, stay the same, and less set up. Where the ONE fell in the 1-of-N would determine what to do. Further, for the 100% UI case the “stay the same” indication would be a ONE in the “middle” of the DT:i.

(We must briefly digress here to dispose of an annoying issue:the pesky notion of “middle.” Suppose you were given ten things arranged in a row. You can define the “middle” as the spot where there are an equal number on each side. Now, identify the thing that is in the middle. It can't be done, unless there is an odd number of things. On the other hand, you can't identify the spot in an odd collection where there are equal numbers of (whole) things on either side. We have a similar difficulty in being certain that, say, DT:(q/2) is in the “middle.” We can cook the subscripts so that for special cases it is, but that trick doesn't last as things change. And change is what the circuit is supposed to deal with. That is, sometimes a measured UI will have an odd number of delay elements associated with it, and sometimes an even number. In the end, we pick one to be the middle, even if it is “off by one,” and since the thing is a servo anyway, we live with sometimes servoing to a location that is (on average) a half-unit of resolution in error. If less error is desired, use more resolution. Meanwhile, we shall henceforth ignore this issue, and speak about “middles” as if they were always identifiable.)

To resume, then, for an ideal situation the array of DT:i would have a middle element (a solitary ONE) that stood for no changed needed, while all those positions (with ZEROs) on one side would indicate “more” while all those positions (with ZEROs) on the other indicate “less.” A need for a phase adjustment is indicated when the ONE appears in a different position. The total number of positions does not change, so if the ONE appears in the middle of what used to be the “more” field, the “more” field of positions just got smaller, and the size of the “less” field got correspondingly larger. Such is the nature of a “1-of-N” indication.

All this is support for the assertion that what we need to do in order to accommodate changes in UI is to shift the “natural” position of the “no change needed” indication over by an amount, and in a direction corresponding to, the shift in proper clock location that corresponds to the measured change in the Unit Interval. The shift in the proper clock location is, of course, the previously mentioned half of the change in the UI. So, what goes on inside the Selection Matrix is a UI dependent shift of the DT:i before they get applied to the outputs of the Selection Matrix, and thence to the OR gates 39 and 40.

To conclude our discussion of FIG. 2, the set up amount adjustment signals 41 and 42 are applied to a Delay Counter 43. If the variable delay applied to CLK 23 to produce CLKD 5 has twenty steps, then Delay Counter 43 will have a range of twenty counts, be initialized to a count in the middle of that range, and count up or down from that middle count as instructed. We have arranged things in the figure such that counting up causes more set up, which equates to more delay applied to CLK to produce CLKD. Hence, the MAKE MORE SET UP signal 41 is coupled to an INC (for INCrement) input of the Delay Counter 43. In like fashion, the MAKE LESS SET UP signal 42 is coupled to a DECrement input.

The counter 43 can be a binary counter. It is desirable, although not essential, that it “get stuck” and not count beyond the range corresponding to the number of delay elements that can invoked to adjust CLKD. In the figure, the m-many bits 47 from the Delay Counter 43 are coupled to an Encoder 48. It turns the binary count into a 1-of-q representation 49 that is applied to the Variable Delay 50. Those q-many signals 49 are labeled UDLY:[1 -q] (the UDLY:i stand for Use Delays 1, 2, . . . , i). It is true that the Delay Counter 43 could directly produce the UDLY:i to begin with, and that we might dispense with the Encoder 48. Or we dispense with the Delay Counter 43 and Encoder 48 in favor of a pre-loaded shift register that is shifted instead of incremented or decremented. The counter arrangement depicted has simplicity, and perhaps one other advantage. If one were inclined to dampen the response of the servo loop we are forming, the least significant bit (or two) of the counter 43 could be ignored, the range of the counter increased correspondingly, and the remaining m-many most significant bits sent to the Encoder 48. This would have the effect of requiring two (or four) INCrements (and also DECrements) to cause a change in the applied delay for CLKD. This can provide useful hysteresis to reduce the tendency of the servo to hunt.

There is one other way to obtain a similar hysteresis. One could group one or more of the outputs adjacent to the signal NO CHANGE/CLKD OK 35 into one logical signal otherwise treated the same as signal 35. We don't favor this, as it produces the hysteresis at the expense of using up range of adjustment.

Continuing, the Fixed Delay 51 of 40% UI that CLK 23 experiences before being applied to the Variable Delay 50 to become CLKD 5 corresponds to the 40% UI delay element 25 in Time Ruler 24.

In final regard to FIG. 2, note the Watch Dog Circuit 36. It is optional. We also note that we have not otherwise used the signal NO CHANGE/CLKD OK 35. What such a Watch Dog circuit would do (and there are many examples in the prior art of nifty watch dog circuits) is require that there be an occasional signal 35, or else it assumes that the servo has gone out to lunch and needs to be restarted in the middle of its range. Signal 44 from the Watch Dog circuit is coupled to an OR gate 45 whose output 46 is the PRELOAD input to the Delay Counter 43. We have not shown it, but signal 44 could force other actions too, such as asserting UI100 or initiating a re-discovery of the Unit Interval. A more sophisticated Watch Dog might try resetting the Delay Counter first, and if that didn't work, then forcing a Unit Interval discovery operation. These are system architecture choices that are now open to the designer once the mechanisms of FIGS. 1 and 2 are in being.

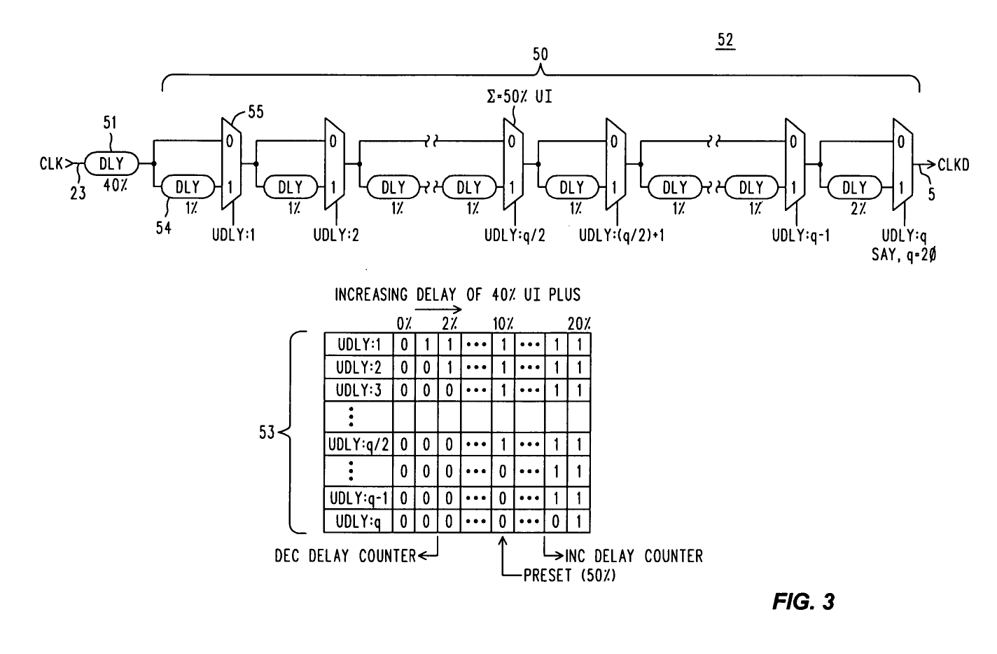

Now turn to FIG. 3, wherein is shown the essentials 52 of the Variable Delay 50 and a truth table 53 that relates its operation to the UDLY:i produced by the Encoder 48 of FIG. 2. Note that each UDLY signal controls the inclusion of a corresponding delay element (DLY 54 controlled by UDLY:1's effect on MUX 55 is representative), with the result of a monotonically varying cumulative delay as the number of UDLY:i's that are ONEs increases or decreases one at a time. Ordinarily, for an ideal condition of 50% UI and no clock phase correction needed, that cumulative delay would be at 50% UI with UDLY:[1-(q/2)] being ONEs.

In final reference to the figures, turn now to FIG. 4. It is a functional description 56 of the shifting needed within the Selection Matrix 22. At this point in the explanation, and in light of the figure itself, the logical structure of the shifting is believed to require no further explanation. It will be appreciated that it takes the DT:i (which indicate where a transition in the data occurred) and connects them to a subset of the NDT:[1-30] (NDT stands for Normalized Data Transition). The size of the subset is the original DT:i , while the location of the subset shifts within the full range of the NDT:[1-30] according to the Measured UI to keep the correct “middle” lined up with the NO CHANGE/CLKD OK signal 35, which we might also call NDT:16. The reader who is not yet convinced is reminded that we set out a motivation for this style of shifting in connection with the explanation of FIG. 2.

The figure continues to assume the particular sizes for the ranges of DT:i and UI:i that were used in the preceding explanations. We just drew the whole thing with no ellipses or attempts at generalization, although in a stylized manner described below. Doing so made the figure a lot easier to draw, and the rule of correspondence much easier to see. It will, of course, be appreciated that other ranges (and accompanying numbers of delay elements in the Time Rulers and the other delay line for the CLK to CLKD mechanism) are quite possible.

The figure also uses a stylized short heavy bar to indicate a connection device as part of the selection mechanism. There are various ways that this electrical task can be accomplished, and two such ways are shown at the upper right corner of the figure. One involves an AND gate 57 between a row and a column, while the other uses a FET switch 58. These, too, are believed to require no special explanations. It will further be appreciated that the indicated functional behavior of the Selection Matrix could be implemented by means of a state machine, a programmed logic array, genuine software executed on a nearby processor, a look up table, and at least two ways by a suitable farm of MUX's.

Now, in conclusion, we return to the issue of the number and nature of the tapped delay lines that we have called Time Rulers, and their relationship to the Variable Delay used to produce CLKD from CLK. First, it is evident that three separate tapped delay lines could be used. That said, certain relationships are useful. It is clear that the Time Ruler 6 for discovery of UI needs to have a cumulative delay at least as long as the longest UI to be encountered. Save for the left-hand delay (7), the others ought to be of uniform size (called ΔT in the incorporated UNIT INTERVAL DISCOVERY FOR A BUS RECEIVER). If we arrange for the UI Time Ruler 6 to have TR:i that range from 90% UI to 110% UI, in ten steps of ΔT=2% UI, we must realize that the exactly corresponding discrete steps for the phase servo Time Ruler 24 is 45% to 55% in 1% steps.

Now, if we don't share the hardware, there is, in principle, anyway, no otherwise fatal reason to compel the two Time Rulers to correspond in this exact fashion (although the numbers used here are just an example). For example, one could algorithmically combine two results from non-identical different style Time Rulers in software, interpolating liberally as needed to discover an ideal clock delay, and then pick the nearest amount of actually available clock delay, which has its own ΔT that needn't correspond to either of the other two. Compared to what we have shown, such a technique would be rather abstract, and involve a fair amount of overhead if there were not otherwise unused processing resources available. Issues of loop instability come to mind, owing to possible artifacts arising from an awkward granularity of the Time Ruler resolutions, which might become a non-issue if the granularity were small enough. Such an approach still seems pretty ugly.

However, if the two Time Rulers are identical or otherwise nicely related by the two-to-one idea, then the need to interpolate by computation is replaced by the ability to use one indication in place of the other through shifting. But if that is the plan, then they might as well be shared hardware, absent some compelling reason not to do so. (Because we never need them both at the same time.)

Sharing the Time Ruler hardware adds a couple of minor wrinkles. First, a Time Ruler has a native ΔT. The two-to-one relationship can be obtained by grouping the lowest native ΔT (think 1%) into consecutive pairs and treating them as a unit in one case, while individually recognizing the separate 1% ΔT's in the other. So one Time Ruler will have (unless one goes to surgical lengths to prevent it, which is wasteful of hardware) a configuration of twenty 1% delay elements, while the other will be a configuration (of the same stuff) that is ten 2% delay elements, each of which is two 1%'ers in series. So, we lied in FIG. 1 when we said that the TR Time Ruler had a range of TR:[1-k] where k was ten and ΔT was 2%. It is really a string of twenty 1% delays, with every other one taken as TR:1, TR:2, etc. This admission does not hurt FIG. 1 any; it simply has an underlying structure that is slightly more complicated, but that otherwise performs as advertised.

Here is another wrinkle. If the clock phase Time Ruler DD:[0-q] (24) is made of the shared delay line hardware, then is has the same twenty 1% of ΔT delay elements. Why waste half of them simply because we are servoing clock phase? So, we use them all, which is why the indicated range for that Time Ruler (24) is the 20% from 40% UI to 60% UI, rather than the 45% to 55% we mentioned earlier. We simply “balanced the excess,” as it were, about the 50% mark. The somewhat pleasing result is a greater range of phase measurement at still good resolution for phase measurement within the measured UI.

The three registers SZERO 11, SONE 12 and DT 31 can easily all be driven from the same tapped delay line that does double duty as TR:[1-k] and DD:[1-q]. The elements of SZERO and SONE are hooked up to every second tap, while the elements of DT are connected to every tap. All that that does is sometimes give the same node in the hardware two different names. That is not such a big sin.

However, there is one final wrinkle that we have yet to point out. There is a minor structural difference in the way the two Time Rulers are used. TR:[1-k] latches delayed instances of DATA IN according to transitions in DATA IN, while the LDD:i for the Time Ruler DD:[0-q] (which are also obtained from DATA IN) are latched according to CLKD. So in both cases the common hardware gets DATA IN at the input of the “real” Time Ruler. The only difference is what signal is to clock the associated register of latches. In one case it is an inversion of DATA IN, in another DATA IN itself, and in the last case, CLKD. This selection of what signal to use for clocking the latches in the registers (11, 12, 31) is a job for some MUXs (not shown) that select/forward the proper signals according to which of the Unit Interval Discovery Mode or the Clock Servo Mode is in effect. The accompanying implication is that there would also be some supervisory mechanism (not shown) that manages those modes and provides signals (not shown either) that represent them.

Since we share the hardware for the two Time Rulers, the two-to-one relationship is automatically observed without our having to do anything special. Also the two Time Rulers automatically track each other as far as environmental drift and fabrication process variations go. That is a definite plus from hardware sharing, not to mention the reduction in cost and chip real estate. However, it behooves use to mind the native ΔT (the 1% in our examples) and arrange for the Variable Delay 50 that actually adjusts CLK to become CLKD to have 1% step sizes also. To not do so could tempt the overall control loop into instability unless other measures were taken to prevent it. It also seems clear that we ought to provide as many steps for the Variable Delay 50 as there are steps in the clock phase Time Ruler 24 (which is twenty in our example). If Variable Delay 50 is fabricated with the same basic types of delay elements as used in the Time Rulers, then all the delays will have good ΔT correspondence and tracking under variations in environmental conditions.

1. A method of positioning the active edge of a clock signal within the unit interval of a data signal, the method comprising the steps of:
(a) measuring in terms of a ΔT the unit interval of the data signal by:
(a1) applying the data signal to a delay line having taps ΔT apart, the overall delay of the delay line being at least as long as the unit interval;
(a2) latching the logical values appearing at consecutive taps 2ΔT apart upon a transition in the logical value of the data signal;
(a3) generating a measured unit interval signal indicating the length of the unit interval in terms of the number of consecutive latches having the same logical value latched in step (a2);
(b) delaying a clock signal in units of ΔT and by a selected amount;
(c) measuring in terms of ΔT where in the unit interval the delayed clock signal of step (b) exerts an active edge by:
(c1) applying the data signal to a delay line having taps ΔT apart;
(c2) latching the logical values appearing at consecutive taps ΔT apart upon the active edge of the delayed clock signal;
(c3) generating a clock phase signal indicating, in terms of a number of consecutive latches, where in the unit interval a transition occurred in the logical values latched in step (c2);
(d) determining the selected amount of delay of step (b) according to the values of the measured unit interval signal of step (a3) and of the clock phase signal of step (c3).

2. A method as in claim 1 wherein step (d) comprises the step shifting the value of the clock phase signal by an amount and in a direction determined by the value of the measured unit interval signal.

3. A method as in claim 1 further comprising the step of using the same delay line for steps (a) and (c).

4. A method as in claim 1 further comprising the steps of providing the delay line of step (a1) with an initial delay of a first amount that is larger than ΔT and of providing the delay line of step (c1) with an initial delay of a second amount that is larger than ΔT but less than the first amount.
